(19) United States
(12) Patent Application Publication
(10) Pub. No.: US 2009/0165499 A1
(43) Pub. Date: Jul. 2, 2009

(54) Glass-ceramic composition, slurry, and method for manufacturing dielectric ceramic component with high frequency

(75) Inventors: Chin-Hung Wei, Hsinchu City (TW); Yu-Ping Hsieh, Keelung City (TW)

Correspondence Address: REED SMITH LLP, Suite 1400, 3110 Fairview Park Drive, Falls Church, VA, 22042, US

(73) Assignee: Delta Electronics, Inc.

(21) Appl. No.: 12/219,732

(22) Filed: Jul. 28, 2008

(30) Foreign Application Priority Data
Dec. 26, 2007 (TW) 096150228

(51) Int. Cl. C03C 3/066; C03C 3/062; C03B 8/02

(52) U.S. Cl. 65/17.2; 501/53; 501/79

(57) ABSTRACT

The invention discloses a glass-ceramic composition, a slurry, and a method for manufacturing a dielectric ceramic component with high frequency. The glass-ceramic composition comprises 5-30 wt % of aluminum oxide and 70-95 wt % of BiZnBSiAl glass. The invention mixes the glass-ceramic composition with an organic carrier to make a slurry, processes the slurry into green body, and then densities the green body to obtain dielectric ceramic component with high frequency, which can be sintered and densified under low temperature. Accordingly, the product of quality factor and resonance frequency of the component can meet the requirements of high quality factor and dielectric constant for industries.

### CROSS REFERENCE TO RELATED APPLICATIONS

This Non-provisional application claims priority under 35 U.S.C. §119(a) on Patent Application No(s). 096150228 filed in Taiwan, Republic of China on Dec. 26, 2007, the entire contents of which are hereby incorporated by reference.

### BACKGROUND OF THE INVENTION

1. Field of the Invention

The invention relates to a glass-ceramic composition, a slurry, and a method for manufacturing a dielectric ceramic component with high frequency.

2. Description of the Prior Art

Recently, with rapid development of wireless mobile communication systems, such as cellular car phones, portable wireless phones or global positioning systems, a portable apparatus with small volume and light weight has become a natural trend for meeting the commercial demands of the competitive market. Therefore, the requirement of miniaturizing the size of a component or a circuit board is an indispensable theme of research and development at present.

In order to meet the aforesaid requirement, an electronic component with multiple layers for increasing volumetric performance had been developed in the market; as a result, the development of components or boards with high frequency is moved toward multiple layers or miniaturization. However, the component or the board with high frequency is required of being sintered with a low-loss conductor, such as copper or silver. Copper has to be sintered in a de-oxygen air, such as nitrogen gas, to avoid becoming copper oxide. Nevertheless, in the de-oxygen air, the organic binder within the ceramics powder is hard to be separated, and then the manufacturing cost is increased. Besides, the conventional ceramics composition is required to be sintered higher than at 962° C., which is melting point of silver, although silver can be sintered in the air. Accordingly, the research and development of dielectric ceramic material with high frequency which can be sintered and densified at low temperature becomes extremely significant.

As known in the industry, aluminum oxide is capable of high dielectric constant and high quality factor, but the sintering temperature is still higher than 962° C. Properties of aluminum oxide are shown as follows:

Sintering temperature: >1700° C.

Dielectric constant (@GHz): ˜9.8

Quality factor (@GHz): 40,000

Temperature coefficient: −55 ppm/° C.

As known in the industry, titanium oxide is capable of high dielectric constant and high quality factor, but the temperature coefficient of resonance frequency is higher. Properties of titanium oxide are shown as follows:

Sintering temperature: 1450° C., 2 hours

Dielectric constant (@GHz): 100

Quality factor (@GHz): 10,000

Temperature coefficient: 400ppm/° C.

As shown as the aforesaid data, the sintering temperature of aluminum oxide and titanium oxide are higher than 1400° C., both they are unable to satisfy the requirement that the sintering temperature is lower than 962° C. if silver is applied, and the temperature coefficients do not satisfy the specifications as well.

Based upon the demand trend of high frequency communication component with microminiaturization and modular, a dielectric glass-ceramic with high frequency which can be sintered and densified at low temperature will become a significant and critical role. The dielectric glass-ceramic material is required to have high dielectric constant for satisfying the requirement of wave filters with microminiaturization and high quality factor Q, namely low dielectric loss, and for satisfying the requirement of articulation and stability under high temperature in high frequency signal. Furthermore, a kind of metal which can be adapted to a transmission line is depended on the sintering temperature.

In high frequency of 0.9˜30 GHz, in order to satisfy the requirement of the wave filter with microminiaturization, the characteristics mentioned below have to be satisfied for selecting the dielectric glass-ceramic material: (1) High dielectric constant K, which is between 5 and 50 in general. The main reason is that the size decrease of the wave filter relates to K^{1/2}; the higher dielectric constant K, the smaller the size of the wave filters. (2) Low dielectric loss (tan δ), namely, high dielectric quality factor (high Q value). When the dielectric loss is lower, the higher quality factor can be obtained, which can benefit the selection of resonance frequency. Besides, in a high frequency band, the dielectric loss will be increased as the frequency is increased. The main reason is that a damping phenomenon which can change the polarity is generated when a frequency is applied to the dielectric substance. Because the quality factor of a dielectric material is defined by a reciprocal of dielectric loss, it is in a frequency range between 1 GHz and 20 GHz. The product (Q×f) of the quality factor (Q) and the resonance frequency (f) is a constant. (3) TC_{f} as a temperature coefficient of the resonance frequency. In order to assure that the resonance frequency only makes a bit change as the temperature varies, the temperature coefficient is desired to be an approximate zero.

However, when a high dielectric constant is selected for achieving a purpose of microminiaturizing a high frequency communication component, the manufacturing accuracy will be debased accordingly. Furthermore, along with the increase of dielectric constant, the result of the quality factor is decreased, and then the quality and yield rate of high frequency component is debased as well. Accordingly, the dielectric constant of dielectric material is selected between 4 and 40 in general.

Accordingly, the main scope of the invention is to provide a glass-ceramic composition, a slurry, and a method for manufacturing a dielectric ceramic component with high frequency, so as to solve the aforesaid problems.

### SUMMARY OF THE INVENTION

A scope of the invention is to provide a glass-ceramic composition, a slurry, and a method for manufacturing a dielectric ceramic component with high frequency.

Another scope of the invention is to provide a glass-ceramic composition for manufacturing a dielectric ceramic component with high frequency, which includes 5˜30 wt % aluminum oxide or titanium oxide and 70˜95 wt % BiZnBSiAl glass.

Another scope of the invention is to provide a glass-ceramic composition for manufacturing a dielectric ceramic component with high frequency, which includes 15˜25 wt % aluminum oxide or titanium oxide and 75˜85 wt % BiZnBSiAl glass.

Furthermore, it is preferred that the aforesaid BiZnBSiAl glass includes 0.5˜2.5 wt % bismuth oxide, 20˜50 wt % zinc oxide, 35˜75 wt % boron oxide, 1˜15 wt % silicon oxide and 1˜15 wt % aluminum oxide. It should be noticed that the mixing rate of the glass-ceramic composition has no especial limitation and it can be adjusted according to required properties of products.

Another scope of the invention is to provide a glass-ceramic composition for manufacturing a dielectric ceramic component with high frequency, which includes 7˜31 wt % aluminum oxide or titanium oxide and 69˜93 wt % LiAlSiZnB glass.

Another scope of the invention is to provide a glass-ceramic composition for manufacturing a dielectric ceramic component with high frequency, which includes 15˜25 wt % aluminum oxide or titanium oxide and 75˜87 wt % LiAlSiZnB glass.

Furthermore, it is preferred that the aforesaid LiAlSiZnB glass includes 1˜15 wt % lithium oxide, 20˜50 wt % zinc oxide, 30˜70 wt % boron oxide and 1˜20 wt % silicon oxide. It should be noticed that the mixing rate of the glass-ceramic composition has no especial limitation and it can be adjusted according to required properties of products.

Another scope of the invention is to provide a slurry for manufacturing a dielectric ceramic component with high frequency, which includes 35˜45 wt % of an organic carrier and 65˜55 wt % of a dielectric mixture. The dielectric mixture includes 5˜30 wt % aluminum oxide or titanium oxide and 70˜95 wt % BiZnBSiAl glass.

Another scope of the invention is to provide a slurry for manufacturing a dielectric ceramic component with high frequency, which includes 35˜45 wt % of an organic carrier and 65˜55 wt % of a dielectric mixture. The dielectric mixture includes 15˜25 wt % aluminum oxide or titanium oxide and 75˜85 wt % BiZnBSiAl glass.

Furthermore, it is preferred that the aforesaid BiZnBSiAl glass includes 0.5˜2.5 wt % bismuth oxide, 20˜50 wt % zinc oxide, 35˜75 wt % boron oxide, 1˜15 wt % silicon oxide and 1˜15 wt % aluminum oxide. It should be noticed that the mixing rate of the glass-ceramic composition has no especial limitation and it can be adjusted according to required properties of products. Besides, the organic carrier includes a binder of polyethylene glycols, polyvinyl butyral or polyvinyl alcohol, an organic solvent of n-propyl alcohol, toluene or ethanol, or a plasticizer of butyraldehyde.

Another scope of the invention is to provide a slurry for manufacturing a dielectric ceramic component with high frequency, which includes 35˜45 wt % of an organic carrier and 65˜55 wt % of a dielectric mixture. The dielectric mixture includes 7˜31 wt % aluminum oxide or titanium oxide, and 69˜93 wt % LiAlSiZnB glass.

Another scope of the invention is to provide a slurry for manufacturing a dielectric ceramic component with high frequency, which includes 35˜45 wt % of an organic carrier and 65˜55 wt % of a dielectric mixture. The dielectric mixture comprises 15˜25 wt % of aluminum oxide or titanium oxide and 75˜87 wt % of LiAlSiZnB glass.

Furthermore, it is preferred that the aforesaid LiAlSiZnB glass comprises 1˜15 wt % of lithium oxide, 20˜50 wt % of zinc oxide, 30˜70 wt % of boron oxide and 1˜20 wt % of silicon oxide. It should be noticed that the mixing rate of the glass-ceramic composition has no especial limitation and it can be adjusted according to required properties of products. Besides, the organic carrier comprises a binder of polyethylene glycols, polyvinyl butyral or polyvinyl alcohol, an organic solvent of n-propyl alcohol, toluene or ethanol, or a plasticizer of butyraldehyde.

Another scope of the invention is to provide a method for manufacturing a dielectric ceramic component with high frequency. The method comprises steps of: (1) providing a glass-ceramic composition which comprises aluminum oxide or titanium oxide ceramic material and BiZnBSiAl or LiAlSiZnB glass; (2) mixing the glass-ceramic composition with an organic carrier to make a slurry; (3) forming the slurry into a green body; and (4) densifying the green body and further achieving the manufacturing procedure of the dielectric ceramic component with high frequency.

Accordingly, the invention is to add a BiZnBSiAl or LiAlSiZnB glass into an aluminum oxide or a titanium oxide ceramic material and effectively make the sintering temperature decrease to 962° C. or lower, and further a high frequency dielectric ceramic component can be obtained, which is capable of low sintering temperature and can be sintered with high conductive metal, such as silver. In addition, the product of quality factor and resonance frequency of the dielectric ceramic component can meet the requirements of high quality factor and dielectric constant for industries.

The advantage and spirit of the invention may be understood by the following recitations together with the appended drawings.

### BRIEF DESCRIPTION OF THE APPENDED DRAWINGS

The present invention will become more filly understood from the detailed description given herein below and the accompanying drawings which are given by way of illustration only, and thus are not limitative of the present invention, and wherein:

FIG. 1 is a flow chart illustrating a method for manufacturing a dielectric ceramic component with high frequency according to an embodiment of the invention.

FIG. 2 is a flow chart illustrating a step S16 shown in FIG. 1 in detail.

FIG. 3 is a flow chart illustrating a method for manufacturing a multiple layers dielectric ceramic component with high frequency according to another embodiment of the invention.

### DETAILED DESCRIPTION OF THE INVENTION

According to an embodiment of the invention, a glass-ceramic composition which can be sintered with high conductive metal, such as silver, can be obtained by mixing 5˜30 wt % aluminum oxide or titanium oxide with 70˜95 wt % BiZnBSiAl glass. In this embodiment, 15˜25 wt % aluminum oxide or titanium oxide and 75˜85 wt % BiZnBSiAl glass are preferred. It should be noticed that the mixing rate of the glass-ceramic composition has no especial limitation and it can be adjusted according to the required properties of products.

In this embodiment, the BiZnBSiAl glass includes 0.5˜2.5 wt % bismuth oxide, 20˜50 wt % zinc oxide, 35˜75 wt % boron oxide, 1˜15 wt % silicon oxide and 1˜15 wt % aluminum oxide. Preferably, the BiZnBSiAl glass includes 1˜2 wt % bismuth oxide, 30˜40 wt % zinc oxide, 45˜60 wt % boron oxide, 5˜10 wt % silicon oxide and 5˜10 wt % aluminum oxide.

According to another embodiment of the invention, a glass-ceramic composition which can be sintered with high conductive metal, such as silver, can be obtained by mixing 7˜31 wt % aluminum oxide or titanium oxide with 69˜93 wt % LiAlSiZnB glass. In this embodiment, 15˜25 wt % aluminum oxide or titanium oxide and 75˜87 wt % LiAlSiZnB glass are preferred. It should be noticed that the mixing rate of the glass-ceramic composition has no especial limitation and it can be adjusted according to the required properties of products.

In this embodiment, the LiAlSiZnB glass includes 1˜15 wt % lithium oxide, 20˜50 wt % zinc oxide, 30˜70 wt % boron oxide and 1˜20 wt % silicon oxide. Preferably, the LiAlSiZnB glass includes 1˜10 wt % lithium oxide, 30˜40 wt % zinc oxide, 45˜55 wt % boron oxide and 5˜15 wt % silicon oxide.

According to another embodiment of the invention, the invention also provides a slurry for manufacturing a dielectric ceramic component with high frequency. The slurry is obtained by mixing 35˜45 wt % of an organic carrier with 65˜55 wt % of a dielectric mixture. The dielectric mixture comprises 5˜30 wt % aluminum oxide or titanium oxide and 70˜95% BiZnBSiAl glass. In this embodiment, 15˜25 wt % aluminum oxide or titanium oxide and 75˜85 wt % BiZnBSiAl glass are preferred. It should be noticed that the mixing rate of the glass-ceramic composition has no especial limitation and it can be adjusted according to required properties of products.

In this embodiment, the BiZnBSiAl glass includes 0.5˜2.5 wt % bismuth oxide, 20˜50 wt % zinc oxide, 35˜75 wt % boron oxide, 1˜15 wt % silicon oxide and 1˜15 wt % aluminum oxide. Preferably, the BiZnBSiAl glass includes 1˜2 wt % bismuth oxide, 30˜40 wt % zinc oxide, 45˜60 wt % boron oxide, 5˜10 wt % silicon oxide and 5˜10 wt % aluminum oxide.

According to another embodiment of the invention, the invention also provides a slurry for manufacturing a dielectric ceramic component with high frequency. The slurry is obtained by mixing 35˜45 wt % of an organic carrier with 65˜55 wt % of a dielectric mixture. The dielectric mixture includes 7˜31 wt % aluminum oxide or titanium oxide and 69˜93% LiAlSiZnB glass. In this embodiment, 15˜25 wt % aluminum oxide or titanium oxide and 75˜87 wt % LiAlSiZnB glass are preferred. It should be noticed that the mixing rate of the glass-ceramic composition has no especial limitation and it can be adjusted according to required properties of products.

In this embodiment, the LiAlSiZnB glass includes 1˜15 wt % lithium oxide, 20˜50 wt % zinc oxide, 30˜70 wt % boron oxide and 1˜20 wt % silicon oxide. Preferably, the LiAlSiZnB glass includes 1˜10 wt % lithium oxide, 30˜40 wt % zinc oxide, 45˜55 wt % boron oxide and 5˜15 wt % silicon oxide.

With reference to the aforesaid slurry, the organic carrier comprise a binder of polyethylene glycols, polyvinyl butyral or polyvinyl alcohol, an organic solvent of n-propyl alcohol, toluene and ethanol, or a plasticizer of butyraldehyde.

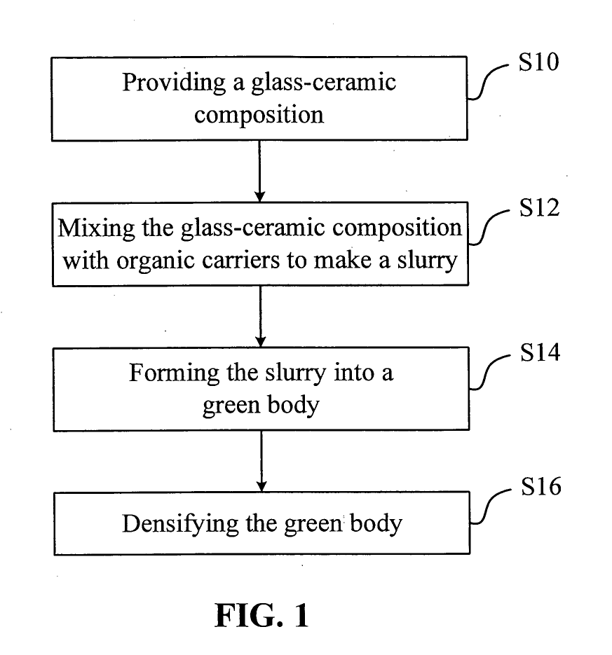

The invention further relates to a method for manufacturing a dielectric ceramic component with high frequency. FIG. 1 is a flow chart illustrating a method for manufacturing a dielectric ceramic component with high frequency according to an embodiment of the invention. As shown in FIG. 1, first of all, step S10 is performed to provide a glass-ceramic composition. The glass-ceramic composition includes aluminum oxide or titanium oxide and BiZnBSiAl or LiAlSiZnB glass. Then, step S12 is performed to mix the glass-ceramic composition with an organic carrier to make a slurry. Afterward, step S14 is performed to form the slurry into a green body. Finally, step S16 is performed to density the green body and further complete the manufacturing procedure of high frequency dielectric ceramic component which can be sintered at low temperature.

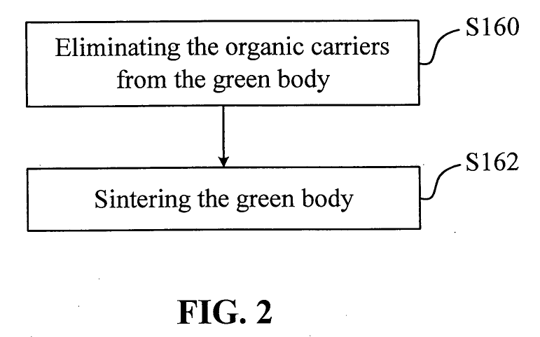

In addition, please refer to FIG. 2. FIG. 2 is a flow chart illustrating a step S16 shown in FIG. 1 in detail. As shown in FIG. 2, first, sub-step S160 is performed to defat the green body for eliminating the organic carrier from the green body. Afterward, sub-step S162 is then performed to sinter the green body for densifying the green body.

In this embodiment, the aforesaid step of densifying the green body (step S16) is preferred to be processed under the existence of air or nitrogen/hydrogen gas. Besides, the green body is densified at a temperature not higher than 962° C. When the green body is sintered at a temperature between 750° C. and 900° C., a sintering time is preferably for 10-60 minutes. When the green body is sintered at a temperature between 550° C. and 750° C., a sintering time is preferably for 10-60 minutes. Dielectric constant of the dielectric ceramic component obtained from the invention is between 7 and 11, and a product of quality factor and resonance frequency is between 800 and 5000 which satisfies the requirements of high quality factor and dielectric constant for industries.

Furthermore, in the step S10, the glass-ceramic composition for making ceramic green body includes 5˜30 wt % aluminum oxide or titanium oxide ceramic material and 75˜95 wt % BiZnBSiAl glass. Moreover, 15˜25 wt % aluminum oxide or titanium oxide ceramic material and 75˜85 wt % BiZnBSiAl glass are preferred. It should be noticed that the mnixing rate of the glass-ceramic composition has no especial limitation and it can be adjusted according to required properties of products.

In the step S10, the BiZnBSiAl glass includes 0.5˜2.5 wt % bismuth oxide, 20˜50 wt % zinc oxide, 35˜75 wt % boron oxide, 1˜15 wt % silicon oxide and 1˜15 wt % aluminum oxide. Preferably, the BiZnBSiAl glass includes 1˜2 wt % bismuth oxide, 30˜40 wt % zinc oxide, 45˜60 wt % boron oxide, 5˜10 wt % silicon oxide and 5˜10 wt % aluminum oxide.

In another embodiment, in the step S10, the glass-ceramic composition for making ceramic green body includes 7˜31 wt % aluminum oxide or titanium oxide ceramic material and 69˜93 wt % LiAlSiZnB glass. Moreover, 15˜25 wt % aluminum oxide or titanium oxide ceramic material and 75˜87 wt % LiAlSiZnB glass are preferred. Furthermore, the LiAlSiZnB glass includes 1˜15 wt % lithium oxide, 20˜50 wt % zinc oxide, 30˜70 wt % boron oxide and 1˜20 wt % silicon oxide. Preferably, the LiAlSiZnB glass includes 1˜10 wt % lithium oxide, 30˜40 wt % zinc oxide, 45˜55 wt % boron oxide and 5˜15 wt % silicon oxide.

In the step S12, the organic carrier includes a binder of polyethylene glycols, polyvinyl butyral or polyvinyl alcohol, an organic solvent of n-propyl alcohol, toluene or ethanol, or a plasticizer of butyraldehyde.

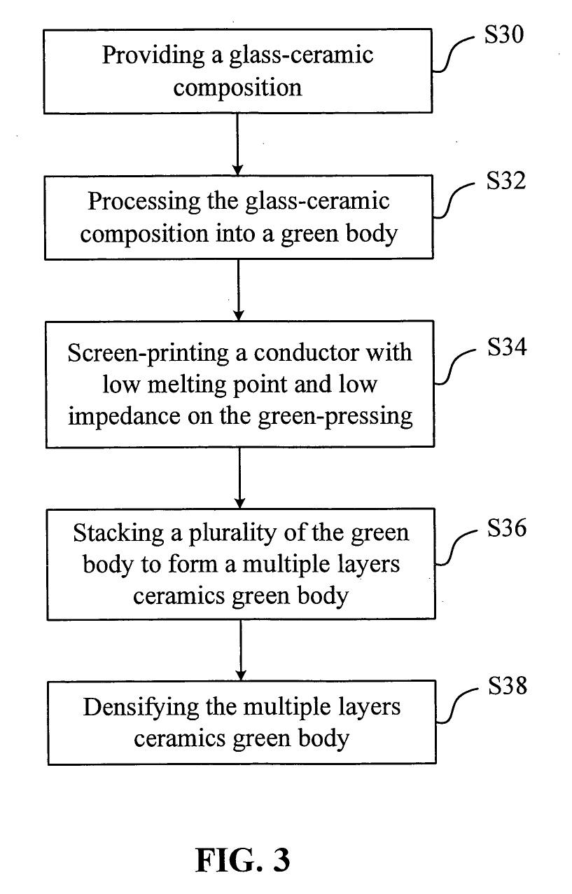

The invention further relates to a method for manufacturing a multiple layers dielectric ceramic component with high frequency. Please refer to FIG. 3. FIG. 3 is a flow chart illustrating a method for manufacturing a multiple layers dielectric ceramic component with high frequency according to another embodiment of the invention. As shown in FIG. 3, first of all, step S30 is performed to provide a glass-ceramic composition. The glass-ceramic composition includes aluminum oxide or titanium oxide and BiZnBSiAl or LiAlSiZnB glass. Then, step S32 is performed to process the glass-ceramic composition into a slurry. Next, step S34 is then performed to screen print a conductor with low melting point and low impedance on the green body. Afterward, step S36 is performed to stack a plurality of the green body to form a multiple layers ceramics green body. Finally, step S38 is performed to densify the multiple layers ceramics green body and further complete the manufacturing procedure of multiple layers high frequency dielectric ceramic component which can be sintered at low temperature.

In the step S30, the dielectric composition for making ceramic green body of ceramic material includes 5˜30 wt % aluminum oxide or titanium oxide ceramic material and 75˜95 wt % BiZnBSiAl glass. Furthermore, 15˜25 wt % aluminum oxide or titanium oxide ceramic material and 75˜85 wt % BiZnBSiAl glass are preferred. It should be noticed that the mixing rate of the glass-ceramic composition has no especial limitation and it can be adjusted according to required properties of products.

In addition, in the step S30, the BiZnBSiAl glass includes 0.5˜2.5 wt % bismuth oxide, 20˜50 wt % zinc oxide, 35˜75 wt % boron oxide, 1˜15 wt % silicon oxide and 1˜15 wt % aluminum oxide. Preferably, the BiZnBSiAl glass includes 1˜2 wt % bismuth oxide, 29˜40 wt % zinc oxide, 45˜60 wt % boron oxide, 5˜10 wt % silicon oxide and 5˜10 wt % aluminum oxide.

In the step S30 according to another embodiment, the dielectric composition for making ceramic green body of ceramic material includes 7˜31 wt % aluminum oxide or titanium oxide ceramic material and 69˜93 wt % LiAlSiZnB glass. Furthermore, 15˜25 wt % aluminum oxide or titanium oxide ceramic material and 75˜87 wt % LiAlSiZnB glass are preferred. It should be noticed that the mixing rate of the glass-ceramic composition has no especial limitation and it can be adjusted according to required properties of products.

In addition, in the step S30, the LiAlSiZnB glass includes 1˜15 wt % lithium oxide, 20˜50 wt % zinc oxide, 30˜70 wt % boron oxide and 1˜20 wt % silicon oxide. Preferably, the LiAlSiZnB glass includes 1˜10 wt % lithium oxide, 30˜40 wt % zinc oxide, 45˜55 wt % boron oxide and 5˜15 wt % silicon oxide.

As for the techniques and other efficacy adopted by the invention presented, the following several experimental exemplifications are provided for further explanation:

Experimental Exemplification One:

Firstly, mix aluminum oxide with BiZnBSiAl glass in several mixing rates listed as table 1 to obtain several kinds of glass-ceramic powders. Then, add 10 ml 1-propyl alcohol, 5 wt % polyethylene glycol 200 (PEG 200), and 10 pellets of 10 mm ceria stabilised zirconia grinding media into each kind of glass-ceramic powder which is 10 grams gross weight, and then mix them by utilizing three-dimensions powder mixing instrument for 2 hours. Afterward, a powder is ground by utilizing a mortar and a pestle after baking at 80° C. for 1 hour. If there are no especial statements, a testing slice is formed from each 2.5 grams powder by a circular mold with 15 mm diameter and remained 15 seconds under 9 MPa to compress the powder to form a green body. Afterward, the green body is sintered in air at a temperature between 550° C. and 750° C. for 10-60 minutes. Finally, measure properties of each sintered slice in low frequency of 1 MHz by utilizing LCR meter, measure a quality factor and a dielectric constant in high frequency of each sintered slice by utilizing a method of Hakki and Coleman, and further measure a range of temperature coefficient of resonance frequency at a temperature between −20° C. and 80° C. The results of Experimental Exemplification One are listed in table 1.

TABLE 1

| Glass | Al₂O₃ | K | Qxf@2.4 GHz |
|---|---|---|---|
| 92 | 8 | 9.0 | 370 |
| 86 | 14 | 10.5 | 1080 |
| 82 | 18 | 11.9 | 2880 |
| 78 | 22 | 11.0 | 369 |
| 74 | 26 | 8.6 | 120 |

Furthermore, the aforesaid sintering process can be divided into two stages. The first stage is defatting process, which heats the green body with a heating rate of 5° C./min to slowly eliminate the organic carrier from the green body. In order to eliminate completely, the temperature will be maintained at 500° C. for 1 hour. In the second stage, the temperature will be raised to a sintering temperature with a heating rate between 5° C./min and 15° C./min and be maintained at the sintering temperature for 10-60 minutes until the furnace cools down.

Experimental Exemplification Two:

Firstly, mix titanium oxide with BiZnBSiAl glass in several mixing rates listed as table 2 to obtain several kinds of glass-ceramic powders. Then, add 10 ml 1-propyl alcohol, 5 wt % polyethylene glycol 200 (PEG 200), and 10 pellets of 10 mm ceria stabilised zirconia grinding media into each kind of glass-ceramic powders which is 10 grams gross weight, and mix them by utilizing three-dimensions powder mixing instrument for 2 hours. Afterward, a powder is ground by utilizing a mortar and a pestle after baking at 80° C. for 1 hour. If there are no especial statements, a testing slice is formed from each 2.5 grams powder by a circular mold with 15 mm diameter and remained 15 seconds under 9 MPa to compress the powder to form a green-press. Afterward, the green body is sintered in air at a temperature between 550° C. and 750° C. for 10-60 minutes. Finally, measure properties of each sintered slice in low frequency of 1 MHz by utilizing LCR meter, measure a quality factor and a dielectric constant in high frequency of each sintered slice by utilizing a method of Hakki and Coleman, and further measure a range of temperature coefficient of resonance frequency at a temperature between −20° C. and 80° C. The results of Experimental Exemplification Two are listed in table 2.

TABLE 2

| Glass | TiO₂ | K | Qxf@2.4 GHz | Tf |
|---|---|---|---|---|
| 93 | 7 | 7.2 | 960 | |
| 90 | 10 | 9.5 | 2146 | −5 |
| 87 | 13 | 16.4 | 4430 | −27 |
| 84 | 16 | 11.0 | 634 | |
| 81 | 19 | 6.5 | 120 | |

Furthermore, the aforesaid sintering process can be divided into two stages. The first stage is defatting process, which heats the green body with a heating rate of 5° C./min to slowly eliminate the organic carrier from the green body. In order to eliminate completely, the temperature will be maintained at 500° C. for 1 hour. In the second stage, the temperature will be raised to a sintering temperature with a heating rate between 5° C./min and 15° C./min and be maintained at the sintering temperature for 10-60 minutes until the furnace cools down.

Experimental Exemplification Three:

Firstly, mix aluminum oxide with LiAlSiZnB glass in several mixing rates listed as table 3 to obtain several kinds of glass-ceramic powders. Then, add 10 ml 1-propyl alcohol, 5 wt % polyethylene glycol 200 (PEG 200), and 10 pellets of 10 mm ceria stabilised zirconia grinding media into each kind of glass-ceramic powder which is 10 grams gross weight, and then mix them by utilizing three-dimensions powder mixing instrument for 2 hours. Afterward, a powder is ground by utilizing a mortar and a pestle after baking at 80° C. for 1 hour. If there are no especial statements, a testing slice is formed from each 2.5 grams powder by a circular mold with 15 mm diameter and remained 15 seconds under 9 MPa to compress the powder to form a green-press. Afterward, the green body is sintered in air at a temperature between 550° C. and 750° C. for 10-60 minutes. Finally, measure properties of each sintered slice in low frequency of 1 MHz by utilizing LCR meter, measure a quality factor and a dielectric constant in high frequency of each sintered slice by utilizing a method of Hakki and Coleman, and further measure a range of temperature coefficient of resonance frequency at a temperature between −20° C. and 80° C. The results of Experimental Exemplification One are listed in table 3.

TABLE 3

| Glass | Al₂O₃ | K | Qxf@2.4 GHz |
|---|---|---|---|
| 83 | 17 | 7.8 | 530 |
| 80 | 20 | 8.0 | 550 |
| 76 | 24 | 8.2 | 578 |
| 71 | 29 | 7.8 | 540 |
| 69 | 31 | 7.3 | 450 |

Furthermore, the aforesaid sintering process can be divided into two stages. The first stage is defatting process, which heats the green body with a heating rate of 5° C./min to slowly eliminate the organic carrier from the green body. In order to eliminate completely, the temperature will be maintained at 500° C. for 1 hour. In the second stage, the temperature will be raised to a sintering temperature with a heating rate between 5° C./min and 15° C./min and be maintained at the sintering temperature for 10-60 minutes until the furnace cools down.

Experimental Exemplification Four:

Firstly, mix titanium oxide with LiAlSiZnB glass in several mixing rates listed as table 4 to obtain several kinds of glass-ceramic powders. Then, add 10 ml 1-propyl alcohol, 5 wt % polyethylene glycol 200 (PEG 200), and 10 pellets of 10 mm ceria stabilised zirconia grinding media into each kind of glass-ceramic powders which is 10 grams gross weight, and mix them by utilizing three-dimensions powder mixing instrument for 2 hours. Afterward, a powder is ground by utilizing a mortar and a pestle after baking at 80° C. for 1 hour. If there are no especial statements, a testing slice is formed from each 2.5 grams powder by a circular mold with 15 mm diameter and remained 15 seconds under 9 MPa to compress the powder to form a green-press. Afterward, the green body is sintered in air at a temperature between 550° C. and 750° C. for 10-60 minutes. Finally, measure properties of each sintered slice in low frequency of 1 MHz by utilizing LCR meter, measure a quality factor and a dielectric constant in high frequency of each sintered slice by utilizing a method of Hakki and Coleman, and further measure a range of temperature coefficient of resonance frequency at a temperature between −20° C. and 80° C. The results of Experimental Exemplification Two are listed in table 4.

TABLE 4

| Glass | TiO₂ | K | Qxf@2.4 GHz | Tf |
|---|---|---|---|---|
| 93 | 7 | 4.8 | 640 | |
| 90 | 10 | 6.33 | 1430.7 | −7.5 |
| 87 | 13 | 10.93 | 2953.3 | −25.5 |
| 84 | 16 | 7.33 | 1624.7 | |
| 81 | 19 | 4.33 | 550 | |

Furthermore, the aforesaid sintering process can be divided into two stages. The first stage is defatting process, which heats the green body with a heating rate of 5° C./min to slowly eliminate the organic carrier from the green body. In order to eliminate completely, the temperature will be maintained at 500° C. for 1 hour. In the second stage, the temperature will be raised to a sintering temperature with a heating rate between 5° C./min and 15° C./min and be maintained at the sintering temperature for 10-60 minutes until the furnace cools down.

Compared with prior art, the invention is to add a BiZnBSiAl or LiAlSiZnB glass into an aluminum oxide or a titanium oxide ceramic material and effectively make the sintering temperature decrease to 962° C. or lower, and further a high frequency dielectric ceramic component can be obtained, which is capable of low sintering temperature and can be sintered with high conductive metal, such as silver. In addition, the product of quality factor and resonance frequency of the dielectric ceramic component can satisfy the requirements of high quality factor and dielectric constant for industry.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A glass-ceramic composition comprising:
aluminum oxide or titanium oxide; and
BiZnBSiAl or LiAlSiZnB glass.

2. The glass-ceramic composition of claim 1, wherein the glass-ceramic composition contains 5˜30 wt % the aluminum oxide or titanium oxide, and 70˜95 wt % the BiZnBSiAl glass.

3. The glass-ceramic composition of claim 1, wherein the BiZnBSiAl glass comprises 0.5˜2.5 wt % of bismuth oxide, 20˜50 wt % of zinc oxide, 35˜75 wt % of boron oxide, 1˜15 wt % of silicon oxide and 1˜15 wt % of aluminum oxide.

4. The glass-ceramic composition of claim 1, wherein the content of the LiAlSiZnB glass in the glass-ceramic composition is 69˜93 wt % and the content of the aluminum oxide or titanium oxide in the glass-ceramic composition is of 7˜31 wt %.

5. The glass-ceramic composition of claim 1, wherein the LiAlSiZnB glass comprises 1˜15 wt % lithium oxide, 20˜50 wt % zinc oxide, 30˜70 wt % boron oxide and 1˜20 wt % silicon oxide.

6. A slurry for manufacturing a dielectric ceramic component, comprising:
an organic carrier; and
a dielectric mixture comprising aluminum oxide or titanium oxide and BiZnBSiAl or LiAlSiZnB glass.

7. The slurry of claim 6, wherein the slurry contains 35˜45 wt % the organic carrier and 65˜55 wt % the dielectric mixture.

8. The slurry of claim 6, wherein the content of the aluminum oxide or titanium oxide in the dielectric mixture is 5˜30 wt % , and the content of the BiZnBSiAl glass in the dielectric mixture is 70˜95 wt %.

9. The slurry of claim 6, wherein the BiZnBSiAl glass comprises 0.5˜2.5 wt % bismuth oxide, 20˜50 wt % zinc oxide, 35˜75 wt % boron oxide, 1˜15 wt % silicon oxide and 1˜15 wt % aluminum oxide.

10. The slurry of claim 6, wherein the content of the aluminum oxide or titanium oxide in the dielectric mixture is 7˜31 wt %, and the content of the LiAlSiZnB glass in the dielectric mixture is 69˜93 wt %.

11. The slurry of claim 6, wherein the LiAlSiZnB glass comprises 1˜15 wt % lithium oxide, 20˜50 wt % zinc oxide, 30˜70 wt % boron oxide and 1˜20 wt % silicon oxide.

12. The slurry of claim 6, wherein the organic carrier comprises a binder of polyethylene glycols, polyvinyl butyral or polyvinyl alcohol, an organic solvent of n-propyl alcohol, toluene or ethanol, a plasticizer of butyraldehyde and any combinations thereof.

13. A method for manufacturing a dielectric ceramic component, comprising steps of:
providing a glass-ceramic composition;
mixing the glass-ceramic composition with an organic carrier to make a slurry;
forming the slurry into a green body; and
densifying the green body;
wherein the glass-ceramic composition comprises aluminum oxide or titanium oxide; and BiZnBSiAl or LiAlSiZnB glass.

14. The method of claim 13, wherein the content of the aluminum oxide or titanium oxide in the glass-ceramic composition is 5˜30%, and the content of the BiZnBSiAl glass in the glass-ceramic composition is 70˜95%.

15. The method of claim 13, wherein the content of the LiAlSiZnB glass in the glass-ceramic composition is 69˜93 wt % and the content of the aluminum oxide or titanium oxide in the glass-ceramic composition is 7˜31 wt %.

16. The method of claim 13, wherein the step of densifying the green body is processed under the existence of air or nitrogen/hydrogen gas.

17. The method of claim 13, wherein the step of densifying the green body further comprises steps of:
eliminating the organic carrier from the green body; and
sintering the green body.

18. The method of claim 17, wherein a temperature for sintering the green body is lower than 962° C.

19. The method of claim 13, wherein the BiZnBSiAl glass comprises 0.5˜2.5 wt % bismuth oxide, 20˜50 wt % zinc oxide, 35˜75 wt % boron oxide, 1˜15 wt % silicon oxide and 1˜15 wt % aluminum oxide.

20. The method of claim 13, wherein the LiAlSiZnB glass comprises 1˜15 wt % lithium oxide, 20˜50 wt % zinc oxide, 30˜70 wt % boron oxide and 1˜20 wt % silicon oxide.

21. The method of claim 13, wherein the organic carrier comprises a binder of polyethylene glycols, polyvinyl butyral or polyvinyl alcohol, an organic solvent of n-propyl alcohol, toluene or ethanol, or a plasticizer of butyraldehyde and any combinations thereof.
